(19) United States
(12) Patent Application Publication
(10) Pub. No.: US 2011/0224939 A1
(43) Pub. Date: Sep. 15, 2011

(54) INTEGRATED TOOL FOR PERSISTING DEVELOPMENT ENVIRONMENT TEST SCENARIO INFORMATION

(76) Inventors: Manish K. Jayaswal, Redmond, WA (US); Prakash Balasubramanian, Bellevue, WA (US); Kevin Halverson, Seattle, WA (US); Sarika Calla, Kirkland, WA (US); David Sterling, Redmond, WA (US); Murad Tariq, Bellevue, WA (US); Eric Maino, Seattle, WA (US)

(21) Appl. No.: 12/720,673

(22) Filed: Mar. 10, 2010

(51) Int. Cl. G06F 19/00

(52) U.S. Cl. 702/123

(57) ABSTRACT

Architecture includes an integrated tool that allows a tester to automatically persist test plan information in association with related content while the tester is interacting with that content in an IDE. The tool further enables the tester to formally associate actions/expectations with specific items of content. In previous solutions, references to existing content are often lost due to inexact or missing descriptions. Formal associations allow for reuse of valuable content and avoid unnecessary recreation. The tool is integrated with the IDE, and thus, does not necessitate that the tester manually type or write descriptions of intent and expectations. This reduces the test plan cost significantly. The tool also persists information in a formal, self-describing format that enables easy consumption by either human testers or secondary software applications (e.g., for the purposes of identifying plans, performing associated actions and verifying expected behavior).

### BACKGROUND

An interactive development environment (IDE) is a software application designed to enable content development. Testers working on the production of the IDE oftentimes create content for the purpose of testing the IDE application. In addition to the content, testers often need to describe a set of test scenarios that require validation. These descriptions specify IDE actions relative to a given item of content. The descriptions can also include the expected behavior of the IDE application when following the specified actions. Creating content and recording test scenarios is highly inefficient due to lack of content reuse and highly manual process. This inefficiency leads to incomplete test scenario coverage.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture includes an integrated tool that allows a tester to automatically persist test scenario information in association with related content while the tester is interacting with that content in an IDE. The tool further enables the tester to formally associate actions/expectations with specific items of content. In previous solutions, references to existing content are often lost due to inexact or missing descriptions. Formal associations allow for reuse of valuable content and avoid unnecessary recreation.

The tool is integrated with the IDE, and thus, does not necessitate that the tester manually type or write descriptions of intent and expectations. This reduces the test plan cost significantly. The tool also persists information in a formal, self-describing format that enables easy consumption by either human testers or secondary software applications (e.g., for the purposes of identifying scenarios, performing associated actions and verifying expected behavior).

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented tool for an integrated development system in accordance with the disclosed architecture.

FIG. 2 illustrates an alternative system of the integrated tool in an IDE application test environment for creating and persisting IDE test plan information.

FIG. 3 illustrates a computer-implemented method in accordance with the disclosed architecture.

FIG. 4 illustrates further aspects of the method of FIG. 3

FIG. 5 illustrates a block diagram of a computing system that executes integrated tool in an IDE application test environment for creating and persisting IDE test plan information in accordance with the disclosed architecture.

### DETAILED DESCRIPTION

General-purpose, stand-alone “test planning” exist that allow testers to persist scenario information by typing a description of the scenario actions and expected behavior. However, the use of this type of tool requires extensive forethought about how to communicate actions/expectations and in terms of typing. Moreover, it is not easy to mentally “switch context” between performing actions in the IDE and writing scenario descriptions, and the value of persisted information depends entirely on the written communication skills of the tester. There is no formal association with the related content.

For IDEs that support automation (e.g., macros), tools exist to automatically record scenario actions. However, the systems can be unreliable in terms of correctly persist all actions; thus, the end result is no better than manually written descriptions. Moreover, the format of persisted actions can be difficult to review and are not easily consumed by secondary processes, and the association with the related content is inflexible.

The disclosed architecture includes an integrated tool that allows a tester to automatically persist test scenario information in association with related content while the tester is interacting with that content in an IDE. The tool further enables the tester to formally associate actions/expectations with specific items of content. In previous solutions, references to existing content are often lost due to inexact or missing descriptions. Formal associations allow for reuse of valuable content and avoid unnecessary recreation.

The tool is integrated with the IDE, and thus, does not necessitate that the tester manually type or write descriptions of intent and expectations. This reduces the test plan cost significantly. The tool also persists information in a formal, self-describing format that enables easy consumption by either human testers or secondary software applications (e.g., for the purposes of identifying scenarios, performing associated actions and verifying expected behavior).

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

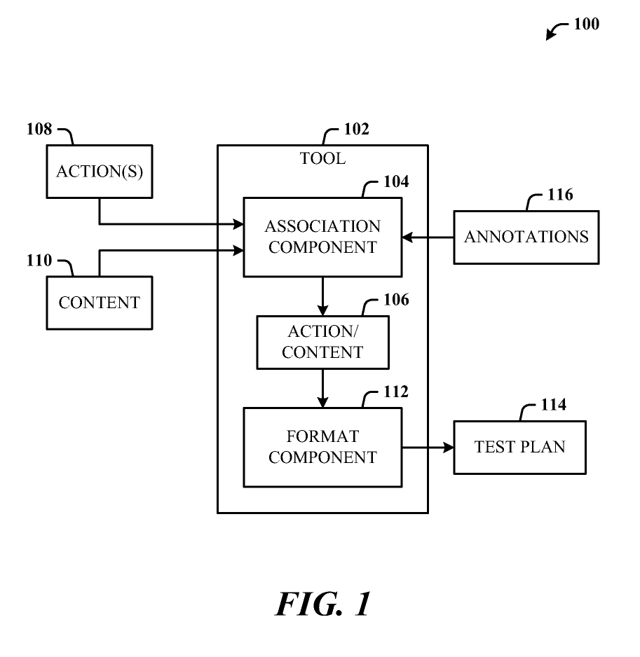

FIG. 1 illustrates a computer-implemented tool 102 for an integrated development system 100 in accordance with the disclosed architecture. The tool 102 includes an association component 104 that enables formal association 106 of an action 108 with content 110, and a format component 112 that captures and formats the association 106 of the content 110 and the action 108 as a reproducible test plan 114.

The test plan 114 is stored in association with the content 110 while the action is occurring with the content 110. The storage of the association 106 of the test plan and the content occurs automatically. The association component 104 and format component 112 are integrated into an interactive development environment application. The format component 112 formats the association 106 in a formal self-describable human-readable representation. The representation describes the test plan, associated actions of the test plan, and expected behavior of the test plan. The association component 104 applies annotations 116 to the content 110 while in a development environment. The annotations 116 capture location information of the content 110 where the action 108 is to be executed.

Put another way, a computer-implemented tool for an integrated development system is provided that comprises an association component of an interactive development environment application that enables formal association of an action with content using annotations of the content while in a development environment, and a format component of the interactive development environment application that captures and formats the association of the content and the action as a reproducible test plan. The test plan is automatically stored in association with the content while the action is occurring with the content. The format component formats the association in a formal self-describable human-readable representation. The representation describes the test plan, associated actions of the test plan, and expected behavior of the test plan. The annotations capture location information of the content where an action is to be executed. The test plan includes updated content and an output file in XML format that is suitable for consumption by a user interface automation tool.

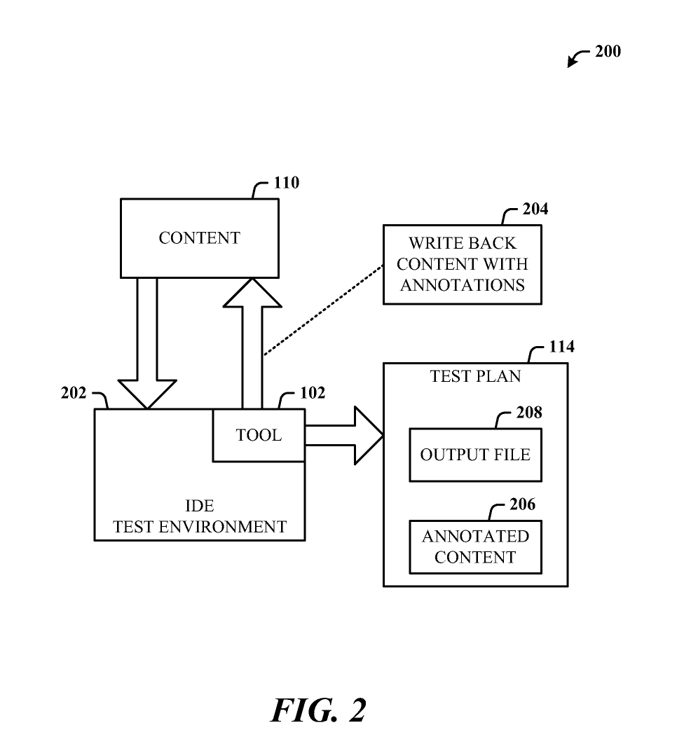

FIG. 2 illustrates an alternative system 200 of the integrated tool 102 in an IDE application test environment 202 for creating and persisting IDE test plan information. The content 110 is accessed by the IDE application and into the test environment where the tool 102 facilitates the annotation and write-back of annotated content (denoted 204) to the content 110 to create updated (annotated) content 206. The tool 102 outputs the test plan 114 that comprises an output file 208 and annotated content 206.

When using this tool 102, testers working on verifying the quality of the IDEs or UI (user interface) that respond or interact with code content, can use already existing content for the purpose of testing. The specification and implementation of the content is usually available before the UI is ready, as it may be a requirement to build the UI that interacts with the content. Hence, the code to test the specifications of the content is also ready before the UI is implemented. For example, compiler tests are ready before the IDE features that interact with the new compiler features. Instead of creating new content, UI testers can now focus on describing the test scenarios on the already-available content.

Testers can go through the content in the IDE and use the tool 102 to annotate the content 110 and create the output file 208 which captures the set of test actions. These annotations capture the information on the location in the content inside the IDE where the tester wants to execute an action. The action to be executed is captured and stored in a separate XML file which includes reference to the annotations made in the content to identify the location where to execute the action. This constitutes a test scenario.

The tool is integrated with the IDE to provide a seamless experience for the tester. The tester is no longer required to manually type or write descriptions of intent and expectations, thereby resulting in a significant reduction in test plan writing cost. The tool 102 also prevents the testers from switching context. Focus is maintained on the task of identifying interesting test scenarios. The updated content along with the XML output file constitute the test plan; hence, the tool 102 helps in quickly persisting the tester intent.

The annotated content and the XML files are both human and machine readable. Thus, a tester can return to the test plan and execute the plan manually. The XML format of the output file can also conform to the format that is used by a UI automation tool. Hence, the test plan can easily be converted into automated UI tests.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

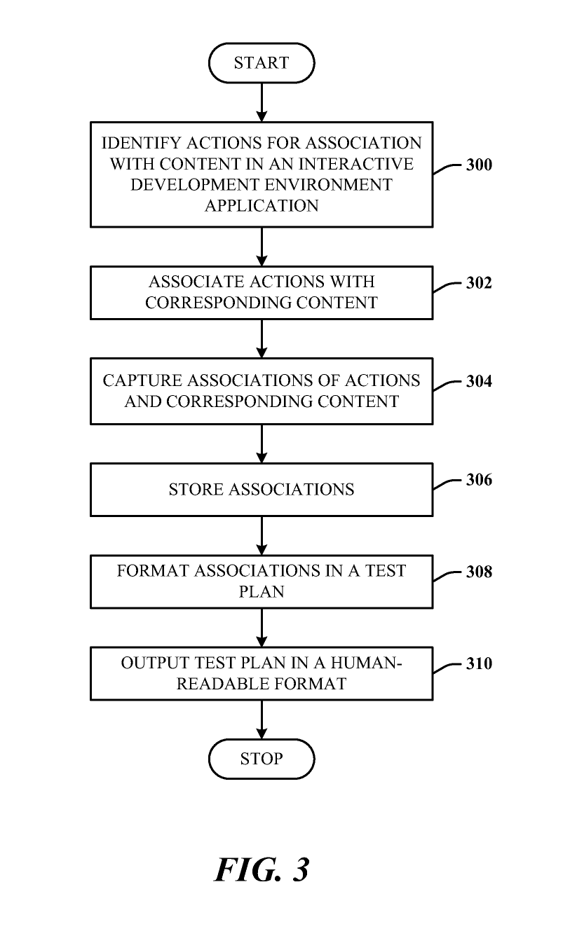

FIG. 3 illustrates a computer-implemented method in accordance with the disclosed architecture. At 300, actions are identified for association with content in an interactive development environment application. This identification process can be performed by a tester. At 302, the actions are associated with the corresponding content. At 304, the associations of the content and the actions are captured. At 306, the associations are stored. At 308, the associations are formatted in a test plan. At 310, the test plan is output in a human-readable format.

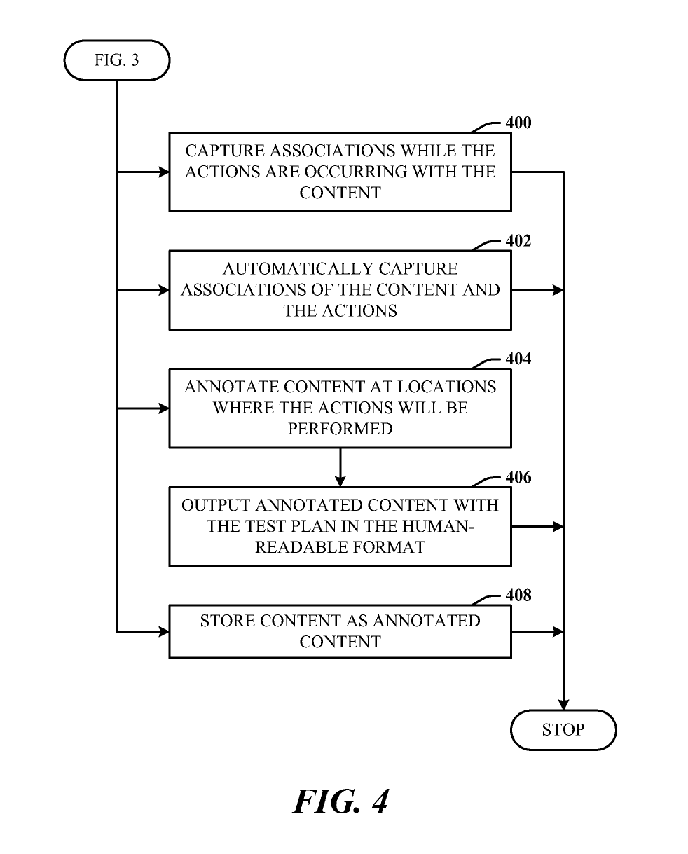

FIG. 4 illustrates further aspects of the method of FIG. 3. At 400, the associations are captured while the actions are occurring with the content. At 402, the associations of the content and the actions are automatically captured. The human-readable format is XML. At 404, the content is annotated at locations where the actions will be performed. At 406, the annotated content is output with the test plan in the human-readable format. At 408, the content is stored as annotated content.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

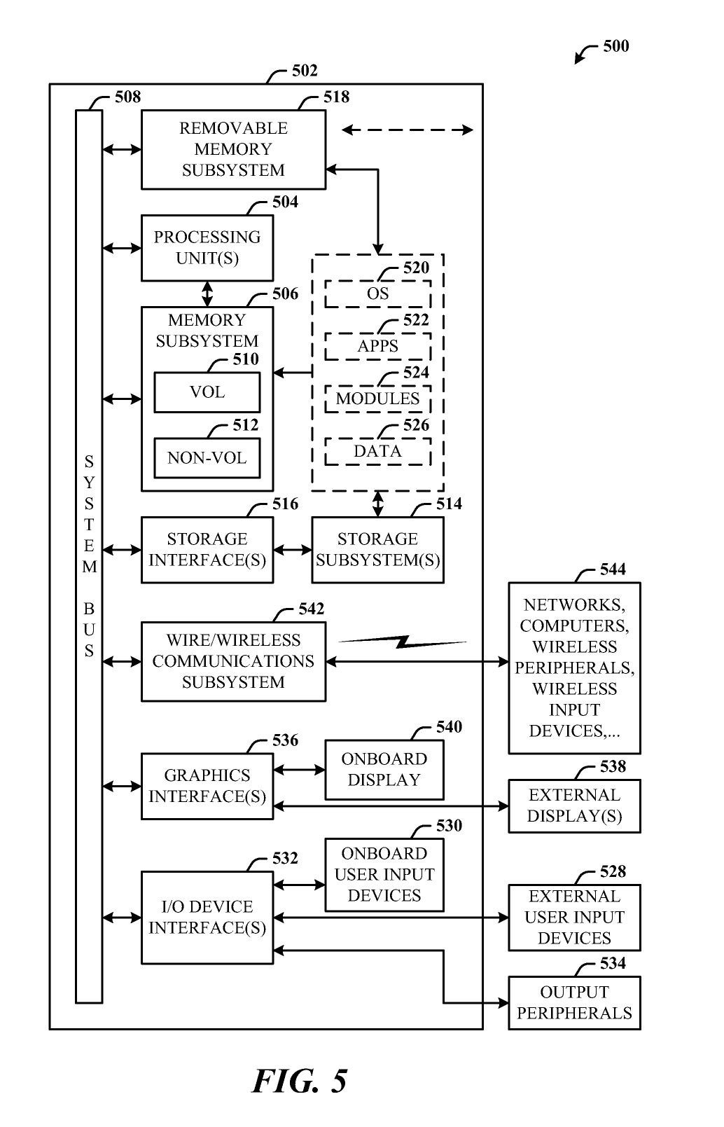

Referring now to FIG. 5, there is illustrated a block diagram of a computing system 500 that executes integrated tool in an IDE application test environment for creating and persisting IDE test plan information in accordance with the disclosed architecture. In order to provide additional context for various aspects thereof, FIG. 5 and the following description are intended to provide a brief, general description of the suitable computing system 500 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 500 for implementing various aspects includes the computer 502 having processing unit(s) 504, a computer-readable storage such as a system memory 506, and a system bus 508. The processing unit(s) 504 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 506 can include computer-readable storage (physical storage media) such as a volatile (VOL) memory 510 (e.g., random access memory (RAM)) and non-volatile memory (NON-VOL) 512 (e.g., ROM, EPROM, EEPROM, etc.). A basic input/output system (BIOS) can be stored in the non-volatile memory 512, and includes the basic routines that facilitate the communication of data and signals between components within the computer 502, such as during startup. The volatile memory 510 can also include a high-speed RAM such as static RAM for caching data.

The system bus 508 provides an interface for system components including, but not limited to, the system memory 506 to the processing unit(s) 504. The system bus 508 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 502 further includes machine readable storage subsystem(s) 514 and storage interface(s) 516 for interfacing the storage subsystem(s) 514 to the system bus 508 and other desired computer components. The storage subsystem(s) 514 (physical storage media) can include one or more of a hard disk drive (HDD), a magnetic floppy disk drive (FDD), and/or optical disk storage drive (e.g., a CD-ROM drive DVD drive), for example. The storage interface(s) 516 can include interface technologies such as EIDE, ATA, SATA, and IEEE 1394, for example.

One or more programs and data can be stored in the memory subsystem 506, a machine readable and removable memory subsystem 518 (e.g., flash drive form factor technology), and/or the storage subsystem(s) 514 (e.g., optical, magnetic, solid state), including an operating system 520, one or more application programs 522, other program modules 524, and program data 526.

The one or more application programs 522, other program modules 524, and program data 526 can include the entities and components of the system 100 of FIG. 1, the entities and components of the system 200 of FIG. 2, and the methods represented by the flowcharts of FIGS. 3 and 4, for example.

Generally, programs include routines, methods, data structures, other software components, etc., that perform particular tasks or implement particular abstract data types. All or portions of the operating system 520, applications 522, modules 524, and/or data 526 can also be cached in memory such as the volatile memory 510, for example. It is to be appreciated that the disclosed architecture can be implemented with various commercially available operating systems or combinations of operating systems (e.g., as virtual machines).

The storage subsystem(s) 514 and memory subsystems (506 and 518) serve as computer readable media for volatile and non-volatile storage of data, data structures, computer-executable instructions, and so forth. The instructions can exist on non-transitory media. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 502 and includes volatile and non-volatile internal and/or external media that is removable or non-removable. For the computer 502, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 502, programs, and data using external user input devices 528 such as a keyboard and a mouse. Other external user input devices 528 can include a microphone, an IR (infrared) remote control, a joystick, a game pad, camera recognition systems, a stylus pen, touch screen, gesture systems (e.g., eye movement, head movement, etc.), and/or the like. The user can interact with the computer 502, programs, and data using onboard user input devices 530 such a touchpad, microphone, keyboard, etc., where the computer 502 is a portable computer, for example. These and other input devices are connected to the processing unit(s) 504 through input/output (I/O) device interface(s) 532 via the system bus 508, but can be connected by other interfaces such as a parallel port, IEEE 1394 serial port, a game port, a USB port, an IR interface, etc. The I/O device interface(s) 532 also facilitate the use of output peripherals 534 such as printers, audio devices, camera devices, and so on, such as a sound card and/or onboard audio processing capability.

One or more graphics interface(s) 536 (also commonly referred to as a graphics processing unit (GPU)) provide graphics and video signals between the computer 502 and external display(s) 538 (e.g., LCD, plasma) and/or onboard displays 540 (e.g., for portable computer). The graphics interface(s) 536 can also be manufactured as part of the computer system board.

The computer 502 can operate in a networked environment (e.g., IP-based) using logical connections via a wired/wireless communications subsystem 542 to one or more networks and/or other computers. The other computers can include workstations, servers, routers, personal computers, microprocessor-based entertainment appliances, peer devices or other common network nodes, and typically include many or all of the elements described relative to the computer 502. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 502 connects to the network via a wired/wireless communication subsystem 542 (e.g., a network interface adapter, onboard transceiver subsystem, etc.) to communicate with wired/wireless networks, wired/wireless printers, wired/wireless input devices 544, and so on. The computer 502 can include a modem or other means for establishing communications over the network. In a networked environment, programs and data relative to the computer 502 can be stored in the remote memory/storage device, as is associated with a distributed system. It will be appreciated that the network connections shown are exemplary and other means of establishing a communications link between the computers can be used.

The computer 502 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated and described aspects can be practiced in distributed computing environments where certain tasks are performed by remote processing devices that are linked through a communications network. In a distributed computing environment, program modules can be located in local and/or remote storage and/or memory system.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented tool for an integrated development system, comprising:
an association component that enables formal association of an action with content; and
a format component that captures and formats the association of the content and the action as a reproducible test plan.

2. The system of claim 1, wherein the test plan is stored in association with the content while the action is occurring with the content.

3. The system of claim 1, wherein the storage of the association of the test plan and the content occurs automatically.

4. The system of claim 1, wherein the association component and format component are integrated into an interactive development environment application.

5. The system of claim 1, wherein the format component formats the association in a formal self-describable human-readable representation.

6. The system of claim 5, wherein the representation describes the test plan, associated actions of the test plan, and expected behavior of the test plan.

7. The system of claim 1, wherein the association component applies annotations of the content while in a development environment.

8. The system of claim 7, wherein the annotations capture location information of the content where the action is to be executed.

9. A computer-implemented tool for an integrated development system, comprising:
an association component of an interactive development environment application that enables formal association of an action with content using annotations of the content while in a development environment; and
a format component of the interactive development environment application that captures and formats the association of the content and the action as a reproducible test plan.

10. The system of claim 9, wherein the test plan is automatically stored in association with the content while the action is occurring with the content.

11. The system of claim 9, wherein the format component formats the association in a formal self-describable human-readable representation, the representation describes the test plan, associated actions of the test plan, and expected behavior of the test plan.

12. The system of claim 9, wherein the annotations capture location information of the content where an action is to be executed.

13. The system of claim 9, wherein the test plan includes updated content and an output file in XML format that is suitable for consumption by a user interface automation tool.

14. A computer-implemented method executable via a processor, comprising:
identifying actions for association with content in an interactive development environment application;
associating the actions with the corresponding content;
capturing the associations of the actions and the corresponding content;
storing the associations;
formatting the associations in a test plan; and
outputting the test plan in a human-readable format.

15. The method of claim 14, further comprising capturing the associations while the actions are occurring with the content.

16. The method of claim 14, further comprising automatically capturing the associations of the content and the actions.

17. The method of claim 14, wherein the human-readable format is XML.

18. The method of claim 14, further comprising annotating the content at locations where the actions will be performed.

19. The method of claim 18, further comprising outputting the annotated content with the test plan in the human-readable format.

20. The method of claim 14, further comprising storing the content as annotated content.
